(19) United States
(12) Patent Application Publication
(10) Pub. No.: US 2010/0191639 A1
(43) Pub. Date: Jul. 29, 2010

(54) EXCHANGES FOR CREATING AND TRADING DERIVATIVE SECURITIES

(75) Inventors: Johnnie Eric Victor Johnson, Southampton (GB); Gyanendra Rao, Southampton (GB)

Correspondence Address: FOGG & POWERS LLC, 5810 W 78TH STREET, SUITE 100, MINNEAPOLIS, MN, 55439, US

(73) Assignee: UNIVERSITY OF SOUTHAMPTON, Southampton (GB)

(21) Appl. No.: 12/532,750

(22) PCT Filed: Mar. 20, 2008
(86) PCT No.: PCT/GB2008/001004

§ 371 Date: Mar. 22, 2010

(30) Foreign Application Priority Data
Mar. 26, 2007 (GB) 0705827.4

(51) Int. Cl. G06Q 40/00; G06Q 90/00

(52) U.S. Cl. 705/37; 705/35; 705/500

(57) ABSTRACT

A computer system (1) constitutes a primary exchange for creating and trading derivative securities that secure a claim of a nominal derivative security value e.g. $1 or £1 that is contingent on movement of a numerical variable such as a stock price. The system comprises: (a) a database (4-14) for storing data defining purchase offers and offers of sale, (b) inputs for receiving offers from traders (16), (c) a decision unit for determining whether or not a match exists between a purchase offer and an offer of sale in the database in terms of the bid and offer prices, the maturity time, stock price at the maturity time, and type of derivative security etc, (d) a derivative security creation module that creates complementary derivative securities, one for each trader, so that only one derivative security will pay out, and (e) a maturity settlement module for paying appropriate traders at the maturity time out of funds received from both traders at commencement of the trade. Derivative securities created by the system may also be traded on the system in a secondary exchange.

This invention relates to trading in financial securities.

There are many types of financial security such as equities, bonds, loans and the like, and many reasons why persons wish to trade in them. For example some people or institutions will wish to use the securities to raise capital or as an investment vehicle, while others may wish to trade in securities in order to reduce the risk of sustaining a loss if certain conditions prevail, for example if the stock market or any particular stock that is traded on it falls. There are also a number of derivative financial securities whose value depends on the value of an underlying asset without necessarily being equal to it.

One form of derivative security is a futures contract, which is a derivative instrument in which two parties agree to transact a set of financial instruments or physical commodities for future delivery at a price agreed today. Futures are standardised by quality, quantity, delivery time (at fixed dates in a given year) and location for each contract. The futures exchange requires each customer to post an initial deposit in the form of cash or acceptable securities prior to commencement of trading, and they must then maintain a margin at the start of each day once the contract is originated so that they are always in funds. This margin account is adjusted at the end of each trading day according to the day's price movements until the expiry of the futures contract. All trades are made via a futures broker/market maker.

For example, with a FTSE 100 futures contract, which notionally purchases an interest in the FTSE 100 index, the contract size is measured in a price per index point, and the trader will make a profit or loss on the difference between the FTSE 100 index on the maturity date and when the futures contract is made. A typical margin requirement may be 10% of the value of the contract, and an initial deposit, the size of which will depend on the futures broker, may be required before the customer can trade. However, if the market goes against the trader between agreeing the contract and maturity of the contract, his account will be debited (known as a margin call) for the difference. The “loss” between purchase of the contract and close of the futures position is therefore subject to market movements and is uncertain. To mitigate potential losses, an additional contract would need to be taken out. In practice stop-loss orders, requiring contracts to be closed, could be in place to limit down-side losses should the market go against the trader.

Another form of derivative security is a contract for difference (CFD), which is a structured agreement between two parties—the trader and the CFD provider (market maker)—to exchange at close of the contract the difference between the opening price of an underlying share at the start of the contract and the price of the underlying share at the close of the contract, multiplied by the number of shares specified. CFDs are open-ended contracts that automatically roll over one day to the next.

Like the futures market, an initial deposit and a margin are required prior to commencement of trading, and the margin may differ depending on the liquidity of the stock, with stocks that are less frequently traded requiring a higher trading margin. The customer's trading account is credited on a daily basis depending on the market movement for the day. The open CFD contracts have to be closed/“sold” to realise a position.

In practice, the CFD provider generally hedges its position by holding the physical securities (stocks) that underlie the CFD contract. Not only may the trader close the contract, the CFD provider may also prematurely close contracts should margins fall below the required amount to protect its own exposure. As with the futures market, stop-loss orders could be in place to limit loss and downside risk.

Yet another form of derivative security is an option. A call (put) option gives the holder the right to buy (sell) an asset for a specific price (strike) on or before an expiry date. Options are exchange traded via a broker, and are traded in units of 100.

When the contract is made, the trader will pay a price which will be a percentage of the underlying asset price. If the value of the underlying asset rises, profit can be realised in either of two ways: by exercising the option and then selling the asset, or, for exchange traded options, by selling the option (whose price will have risen by virtue of the rise in the price of the underlying asset).

Exchange traded equity options are “physical delivery” options, which means that there is a physical delivery of the underlying stock to or from the customer's account if the option is exercised. The owner of an equity option can either exercise the contract at a specific time (for European options) or at any time prior to the exercise deadline (for American options)set by the relevant exchange.

When buying a put or call, the risk or loss to the purchaser is limited to the price that is paid. The seller of the call option, also called the “option writer”, however, has an unlimited risk since he may be required to sell the stock at whatever price it reaches at or before the expiry date.

Exchange traded options require the market makers and brokers to be a member of the Options Clearing Corporation (OCC in USA), obtained by purchasing a seat on the exchange. The members are required to meet a minimum set of financial requirements. Market maker members of the OCC must provide collateral for the positions of options writers (market makers) and both market maker and broker members must contribute to Clearing Funds that protect the OCC against a clearing member's default.

Existing forms of derivative securities thus generally have a number of features that might be regarded as disadvantages for certain traders, for example that the potential gain or loss to one of the traders is not known at commencement of the transaction and so needs to be hedged, or that additional margin calls may be received before the contract is closed. In addition, the financial instruments are only available through market makers, and usually more than one transaction (with associated costs) is required in order to close a position. Also, secondary exchanges to trade directly in the financial derivatives are generally not available.

The present invention proposes an exchange, and a method of operating an exchange, where independently tradable derivative securities can be created by matching the expectations of multiple traders (buyers and sellers) as to changes in the value of an underlying numerical variable. Such traders may include large or small traders, speculators and risk managers in multiple locations.

According to one aspect, the present invention provides a computer system that constitutes a primary exchange for creating derivative securities that secure a claim of a predetermined nominal derivative security value that is contingent on a well defined, externally influenced numerical variable associated therewith at or before a predetermined future time, which system comprises:
(a) a database for storing data defining purchase offers and offers of sale of the derivative securities received from traders, whether buyers or sellers, the database being structured for storing records for each offer including
   (i) the identity of a trader that has made the offer,
   (ii) data indicating whether the offer is a purchase offer or offer for sale,
   (iii) the identity of the numerical variable,
   (iv) numbers representing the price offered by a buyer (the bid price) or the price offered by a seller (the offer price),
   (v) numbers representing the predetermined future time,
   (vi) numbers representing a value of the numerical variable at the predetermined future time or before the predetermined future time that is defined in the offer,
   (vii) data indicating the relationship between the defined value of the numerical variable at or before the predetermined future time specified in the offer and the actual value of the numerical variable at or before the predetermined future time that is required in order for the trader to secure the claim,
   (viii) numbers representing the quantity of derivative securities in the offer;
(b) an input for receiving the data defining the purchase offers from buyers;
(c) an input for receiving the data defining offers of sale from sellers;
(d) a decision unit for determining whether or not a match exists between a purchase offer and an offer of sale in the database in terms of:
   (i) the bid and offer prices, referred to as the agreed trade price if a match is determined,
   (ii) the numerical variable,
   (iii) the predetermined future time,
   (iv) the defined value of the numerical variable at the future time specified in the offer, and
   (v) the relationship between the defined value of the numerical variable specified in the offer and the actual value of the numerical variable at the future time or at a time up to the future time; and
(e) a derivative security creation module that is responsive to output from the decision unit that a match exists in order to create one or more derivative securities, which comprises:
   (i) a trade settlement unit for automatically calculating the agreed number of the derivative securities, being the maximum number of derivative securities that are the subject of both the purchase offer and the offer of sale; calculating the maximum financial obligation of a trader, being substantially the product of the agreed number of derivative securities and the agreed trade price if the trader is a buyer, or substantially the product of the agreed number of derivative securities and the difference between the nominal derivative security value and the agreed trade price if the trader is a seller; automatically receiving funds from traders corresponding to their maximum financial obligation; and
   (ii) a derivative security creation unit for notifying the traders of creation of the derivative security and of data relating to the derivative security, and storing data relating to the derivative security in a database; and
(f) a maturity settlement module for paying appropriate traders at the predetermined future time or before the predetermined future time depending on the type of derivative security, which comprises:
   (i) a maturity data input module for receiving from an external source, data quoted by an independent institution, representing the actual value of the numerical variable at the predetermined future time or before the predetermined future time;
   (ii) a determination module responsive to data from the maturity data input module, for determining, at or before the predetermined future time, whether the actual value of the numerical variable is the same as or is above or below the defined value specified in the offer;
   (iii) a reimbursement module responsive to data from the determination module, for sending to one of the traders or to an agreed third party funds corresponding substantially to the product of the agreed number of the securities and the nominal derivative security value.

The system and method according to the invention have the advantage that they enable derivative securities to be created with a significantly simplified procedure and with reduced costs to traders who will not have to pay fees to market makers whose costs are necessarily passed on to the traders. Further, opening or closing a position in the system according to the invention involves only a single transaction cost. By virtue of the simplification of trading, traders can use the system whether they are traders in large volumes, which one may refer to as institutional investors, or are only small traders, often called retail investors. One important aspect of the system and method according to the invention is that both the price which is agreed by the traders for the derivative security on creation of the derivative security and the price that is to be received by one of the traders on maturity of the derivative security is known at the time the agreement is entered into and the derivative security created. The gain or loss that can be made or suffered by any trader is thus known when the trade is agreed, so that it may not be necessary to hedge any trader's position.

Thus, unlike futures contracts and CFDs, the trader will not be subject to any margin calls if the market goes against him. In addition, unlike futures contracts and CFDs, the potential gain or loss is known at the inception. Further, the derivative securities created according to this invention may be based on a wider set of underlying securities and assets than those currently forming the basis of futures contracts and CFDs and can be based on any well defined externally influenced numerical variable, and there is no risk of default. In addition, with options, the potential loss for the option writer may be unlimited, and the potential gain for the holder of an option contract is a function of the closing price at expiry of the option. With options there is a potential default risk whereby the writer of an option may not be able to deliver the underlying security. Also, currently options are written for fixed periods, for example three or six months, whereas the securities according to the invention may be written for any period. In addition the derivative securities according to the invention do not require that an underlying asset is purchased thus removing related brokerage fees.

Yet a further advantage of the trading system according to the invention is that the traders may receive interest on money that has been held on deposit by the exchange over the period between settlement of the trade and maturity, and that this interest is payable to a trader even if he loses money by the market going against him. There will, on the other hand, inevitably be some transaction and administration costs that are levied on the traders by the exchange. Thus the term “substantially” when referring to the calculation of financial obligations of traders or reimbursement to traders by the exchange is intended to take into account any interest earned on money deposited and any transaction and administration charges, and such interest and charges are implicitly taken into account whenever terms such as “prices”, “values” or “payments” and the like are employed herein.

The numerical variable that is associated with the derivative security may in general be any variable that fluctuates with time and whose value is externally influenced (although it may also be influenced by trading in the exchange), provided that the value at any time is well defined. The variable will also normally be one that relates either directly or indirectly to a risk factor against which one or more traders may wish to insure. Typically the numerical variable will be a financial variable, for example the value of an asset such as an equity, fixed income instrument or a commodity, or it may be an index such as an interest rate index, a stock market index or a currency exchange rate. The asset may be a single asset or a number of assets, for example a portfolio of stocks. However, in the broadest aspect of the invention, other variables, especially variables that affect, or are a reflection of, a risk may be employed. Such variables may include temperature at a specific location or a mean temperature over a geographical area, or other weather related data, average mortality or infection data of populations, crime statistics, greenhouse gas generation and the like. Such data may for example be used to enable insurance companies to mitigate their exposure to such risks. It is preferable that the value of the numerical variable, whether an equity, index, commodity or other figure, be well defined, that it be governed by an impartial custodian, for example a stock or bond exchange, or an official data generation office, and, in the case of financial assets, have a sufficient degree of liquidity so that there is always a market in the assets. Although the derivative securities may be described below with reference to an underlying asset, e.g. an equity, it will be appreciated assets are only an example and that other numerical variables that have no intrinsic “value” may be employed instead.

The system and method according to the invention have the significant advantage over previously proposed exchanges that the form of the derivative securities is created by the traders themselves rather than by the exchange. That is to say, although the overall rules of trading will be set by the exchange, once the exchange has agreed to the liquidity and definition of the underlying variable, the traders can determine what the underlying variable is together with other parameters such as the maturity time, the value of the underlying variable at the maturity time etc. Previously proposed exchanges have had the disadvantage that the parameters defining the contracts made were set by the exchange with the result that only a limited number of contracts were available. For example, one exchange has the disadvantage that contracts may be made relating only to index values rather than specific shares.

The numerical variable may comprise a number of separate variables that are connected by Boolian or other logic provided that the numerical variable gives a single YES/NO instruction at the relevant time as to whether the derivative security should pay out.

References to times such as the predetermined future time will often mean the close of trade where the numerical variable refers to the price of an underlying asset or index, and references to prices of the underlying asset or other financial figures may refer to closing market prices as determined by the exchange or the market in which the underlying asset is being traded and the prices of the assets determined. Thus, for example, for US bonds, the prices on closing of the US bond market may be taken as the final price at the maturity time of the derivative security. However, it is possible for times other than the end of trading to be referred to, and it is possible for prices other than closing prices to be quoted. For example the opening price of an underlying asset on the maturity date may be used. It is even possible for different times during a trading day to be used as maturity times, depending on how the exchange is operated or on the type of derivative security that is created. For example, with derivative securities which can secure a claim if the underlying asset achieves the relevant price before close of trade on the maturity date, it is possible for the claim to be secured at any point of time during the trading day or before, even if the movement in the price of the underlying asset reverses later on during the day. Similarly, it is possible for precise times to be used in general rather than close of trading.

The derivative securities will normally have a predetermined nominal security value of one currency unit (e.g. $1 or £1) or multiples or fractions thereof, and a number of derivative securities will be traded in any one contract. Alternatively, a contract may be for one derivative security having a value of a number of currency units. This is merely a conceptual difference. It is also possible for an exchange to deal with derivative securities in a number of currencies. Where the derivative securities handled by the exchange may have different nominal derivative security values, the database that stores data defining the purchase offers and offers for sale may also contain numbers representing the nominal derivative security value(s).

The relationship between the defined value of the numerical variable specified in the offer and the actual value at the predetermined future time or before the predetermined future time required in order for the trader to secure the claim will normally be whether the actual value of the numerical variable is above, at or below the defined value specified in the offer. In addition, if the value of the numerical variable defined in the offer is the same as the actual value at the predetermined future time, this may be considered as falling below or rising above the actual value depending on the rules of the exchange. All that is important is that the relationship specified in the derivative security created on behalf of the seller and on behalf of the buyer are mutually exclusive and together cover the entire range of possibilities.

In fact, according to a preferred aspect, it is not just a single derivative security that is created if the decision unit determines that a match exists, but rather a pair of complementary derivative securities. Thus the derivative security creation module is operative to create (a) a “buyer” security that will pay the predetermined nominal derivative security value, if, at the predetermined future time or before the predetermined future time, the value of the underlying numerical variable rises to or above, or falls to or below, the predetermined underlying numerical variable value, and (b) a “seller” derivative security that will pay the nominal derivative security value, if at the same time the value of the underlying numerical variable fails to rise to or above or fails to fall to or below respectively, the defined numerical variable value. One derivative security is created in the name of the buyer and the other is created in the name of the seller once all relevant fields have been matched by the decision unit. Since the buyer and seller both receive the nominal derivative security value (if they are able to secure a claim), the buyer's profit will be substantially the nominal derivative security value minus the agreed trade price, whereas the seller's profit will be substantially the agreed trade price.

The derivative securities created by the system and method according to the invention may be traded if desired instead of being held until maturity. The securities may be traded by any means normally used for trading negotiable instruments, for example in a financial exchange. This may if desired be connected to the primary exchange although it is by no means necessarily the case. Thus, according to another aspect, the invention provides a computer system that also constitutes a secondary exchange for trading derivative securities. Such a computer system may include:
(g) a secondary input for receiving purchase offers from traders to buy the existing derivative securities;
(h) a secondary input for receiving offers of sale of the existing derivative securities from traders;
(i) a database for storing the offers to buy and offers to sell;
(j) a secondary decision unit for determining whether or not a match exists between an offer to buy and an offer for sale of an existing derivative security created by the primary exchange in the database in terms of the bid and offer prices of the existing derivative security, the type of derivative security, the underlying numerical variable and the predetermined future time; and
(k) a secondary trade settlement unit for automatically updating databases of the trade if the secondary decision unit determines that a match exists; notifying the traders of transfer of the derivative security from the seller to the buyer, and receiving funds from a trader who has made an offer to buy the existing derivative security that has been matched.

The derivative securities traded by the secondary exchange will normally have been created by the primary exchange, but they may have been created independently.

According to yet another aspect, the invention provides a method of operating a computer system that constitutes a primary exchange for creating derivative securities that secure a claim of a predetermined nominal value that is contingent on a well defined, externally influenced numerical variable associated therewith at or before a predetermined future time, which method comprises the steps of:
(a) receiving data defining the purchase offers from buyers;
(b) receiving data defining offers of sale from sellers;
(c) storing the data defining purchase offers and offers of sale of the derivative securities received from traders, whether buyers or sellers, in a database, the database being structured for storing records for each offer including
   (i) the identity of a trader that has made the offer,
   (ii) data indicating whether the offer is a purchase offer or offer for sale,
   (iii) the identity of the numerical variable,
   (iv) numbers representing the price offered by a buyer (the bid price) or the price offered by a seller (the offer price),
   (v) numbers representing the predetermined future time,
   (vi) numbers representing a value of the numerical variable at the predetermined future time or before the predetermined future time that is defined in the offer,
   (vii) data indicating the relationship between the defined value of the numerical variable at or before the predetermined future time specified in the offer and the actual value of the numerical variable at or before the future time that is required in order for the trader to secure the claim,
   (viii) numbers representing the quantity of derivative securities in the offer;
(d) determining whether or not a match exists between a purchase offer and an offer of sale in the database in terms of:
   (i) the bid and offer prices, referred to as the agreed trade price if a match is determined,
   (ii) the numerical variable,
   (iii) the predetermined future time,
   (iv) the defined value of the numerical variable at the future time specified in the offer, and
   (v) the relationship between the defined value of the numerical variable at the predetermined future time or before the predetermined future time specified in the offer and the actual value of the numerical variable at the predetermined future time or at a time up to the predetermined future time that is required in order for the trader to secure the claim; and
(e) creating a derivative security in response to output from the determining step that a match exists, which step comprises:
   (i) automatically calculating the agreed number of the derivative securities, being the maximum number of derivative securities that are the subject of both the purchase offer and the offer of sale; calculating the maximum financial obligation of a trader, being substantially the product of the agreed number of derivative securities and the agreed trade price if the trader is a buyer, or substantially the product of the agreed number of derivative securities and the difference between the nominal derivative security value and the agreed trade price if the trader is a seller; automatically receiving funds from traders corresponding to their maximum financial obligation; and
   (ii) notifying the traders of creation of the derivative security and of data relating to the derivative security, and storing data relating to the derivative security in a database; and
(f) a maturity settlement step for paying appropriate traders at the predetermined future time or before the predetermined future time depending on the type of derivative security, which comprises:
   (i) a maturity data input step of receiving from an external source, data quoted by an independent institution representing the actual value of the numerical variable at the predetermined future time or before the predetermined future time;
   (ii) a determination step, of determining in response to data from the maturity data input step, at or before the predetermined future time, whether the actual value of the numerical variable is the same as or is above or below the defined value specified in the offer;
   (iii) a reimbursement step of sending to one of the traders or to an agreed third party, funds corresponding substantially to the product of the agreed number of the derivative securities and the nominal derivative security value, in response to data from the determination step.

According to yet another aspect, the invention provides a carrier which carries a computer program comprising computer-implementable instructions for causing a computer to constitute a primary or secondary exchange or for performing a method as specified above.

In both the primary exchange and the secondary exchange it may be desirable, at least under some circumstances, that it is determined whether or not a match is also made in respect of the volume of derivative securities before the trade is completed. Alternatively, it is quite possible for a trade to be made for part of the volume of derivative securities that is on offer if a buyer is prepared to purchase only part thereof, or for trades to be made for the volume of derivative securities offered by a number of sellers.

Although not necessary, it is highly desirable that the secondary exchange is operated in conjunction with the primary exchange so that necessary information concerning the traders and the derivative securities can be passed between the two systems. The secondary exchange may be operated by different hardware from that of the primary exchange or the same hardware. Much of the data required by the two exchanges such as the client list, will be common to both the primary and the secondary exchange, so that the same database is advantageously used for both exchanges.

As stated above, tradable derivative securities are created by matching expectations of different traders as to changes in the value of the underlying numerical variable. This is achieved by means of the primary exchange where trades are made by matching the offers made by the traders to buy and to sell the derivative securities. Thus, the derivative securities created have prices that are set by traders in the market depending on a number of factors including the maturity price of the underlying asset, the traders' expectations of changes in the asset price and the like. Indeed, what may be an appropriate maturity price for one trader may not be appropriate for another trader for reasons that are determined purely by his own circumstances.

A computer system and method of trading risk management contracts has been proposed in WO 2005/114517 in the name of Hedgestreet Inc. In that system, bundles of contracts are created and put on offer by a market authority. Each of the contracts of the bundle will pay out if one of a number of mutually exclusive outcomes occurs, and the circumstance under which any contract will pay out is set by a market authority that runs the computer system. Since only one contract can pay out, the aggregate value of the bundle is equal to the payout of an individual contract. A trader may hedge a risk by buying a bundle of contracts from the market authority and selling one or more individual contracts that he is not interested in from the bundle on the market for what price he can get. This system has the disadvantage that if the circumstances under which any individual contract of the bundle will pay out are not appropriate to that particular trader, it will not be possible for him to hedge his risk in that way.

The derivative securities created by the computer system are novel per se, and so, according to yet another aspect, the invention provides a tradable derivative security, which comprises a legally binding right of an owner thereof to receive a predetermined sum of money, referred to as the nominal derivative security value, in a circumstance that the value of a numerical variable associated with the derivative security determined by an independent institution rises to or above, or falls to or below, a defined value, or fails to rise to or above or to fall to or below the defined value, at a predetermined future time or before a predetermined future time, the nominal derivative security value having been deposited in a secure account and received from the owner and another trader who had agreed with the owner that the owner would receive the nominal derivative security value in the said circumstance and that the other trader would receive the nominal derivative security value in any other circumstance.

The proportion of the nominal derivative security value that is received from the owner and from the other trader are not normally the same, and will normally be determined by trading on an exchange.

According to yet a further aspect, the invention provides a tradable derivative security which comprises a legally binding right of an owner thereof to receive a predetermined sum of money referred to as the nominal derivative security value, in a circumstance that the value of a numerical variable associated with the derivative security determined by an independent institution rises to or above or falls to or below, a defined value, or fails to rise to or above or fails to fall to or below the defined value, at a predetermined future time or before a predetermined future time, the derivative security comprising data stored in a database of a security exchange which defines:
(i) the identity of the owner
(ii) the identity of the numerical variable,
(iii) the predetermined future time,
(iv) the defined value of the numerical variable;
(v) the relationship between the defined value of the numerical variable at or before the future time specified in the derivative security and the actual value of the numerical variable at or before the future time that is required in order for the owner to secure the claim; and
(vi) data identifying funds held in a secure account that were used to purchase the derivative security.

The funds will normally have been deposited in a secure account, preferably one which is independent of the exchange, the funds having been received from the owner together with another person who had agreed with the owner that the owner would receive the funds in the said circumstance and that the other person would receive the funds in any other circumstance. This may be done by the traders themselves or by the exchange at commencement of trading or in advance of any trading by the traders. Of course, a trader need not be an individual. Wherever a trader is referred to herein, this may include a number of traders, for example forming a consortium. The fact that the funds forming collateral for the derivative security have been deposited in an independent account related to the securities created (as opposed to an account relating to the individual traders) means that the securities may be traded by any means normally employed for trading financial instruments, and not solely by using the secondary exchange. Also, the fact that the collateral for the derivative securities is held in a secure independent account rather than by the exchange, there is no risk to any traders of default if the exchange becomes bankrupt. Also, once the trade has been agreed and the derivative securities created, it is not possible for the exchange thereafter to interfere with the securities. The funds will be held in the independent account until maturity of the derivative security.

Because the derivative securities according to the invention are fungible, they may be used as part of a portfolio in place of, or in addition to, other securities such as stocks and options, for example to generate the same return as the other securities, and are capable of substituting, or being substituted by, the other securities.

It is possible, depending on the creditworthiness of the trader, for the trader to pay a fraction of the cost of the trade and the remainder of the cost to be guaranteed by a third party or by the exchange. In any case, it is in general possible for any funds due from, or required to be paid to, traders to be received from or paid to an agreed third party, and references herein to receipt from or payment to a trader are to be understood as including receipt of funds from a third party or payment to a third party.

It is possible for a number of different forms of derivative security, which will pay out under different circumstances, to be created by the system and method according to the invention. The derivative securities are referred to herein as “State Prices in an e-Xchange for Contingencies”, abbreviated to “SPeCs”. The derivative securities may pay the nominal derivative security value if an underlying numerical variable achieves a specified value (hereinafter referred to as the maturity value) at a predetermined time. For example, where the numerical variable relates to the price of a given stock, this may be the close of trade of a stock exchange on a specified date, or if the numerical variable achieves the maturity value at any time up to the predetermined time. Alternatively, the derivative security may pay the nominal derivative security value if the value of the numerical variable falls below a predetermined value at a predetermined future time or falls to a predetermined value at any time before the predetermined future time.

Each matched trade results in two independently tradable derivative securities: a SPeCs(buyer) security and a SPeCs(seller) security.

As regards a buyer security, a SPeCs^{spot+}(buyer) security with a price p secures a contingent claim which pays the nominal derivative security value, for example £1 (or any other convenient currency unit such as $1 or [symbol] 1) if the underlying numerical variable achieves its maturity value or more at any specified time, referred to herein as the “maturity time” or “horizon time”.

A SPeCs^{spot-} (buyer) security with a price p secures a contingent claim which pays the nominal derivative security value if the underlying numerical variable falls to a maturity value or less at the maturity time.

A SPeCs^{gene+} (buyer) security with a price p secures a contingent claim which pays the nominal derivative security value if the underlying numerical variable achieves a maturity value or more at any point in time from creation of the security up to the maturity time.

A SPeCs^{gen-} (buyer) security with a price p secures a contingent claim which pays the nominal derivative security value if the underlying numerical variable falls to a maturity value or less at any point in time from creation of the derivative security up to the maturity time.

For seller securities, there will exist four derivative securities, namely a SPeCs^{spot+}(seller) security which pays the nominal derivative security value if the underlying numerical variable fails to achieve a maturity value or more at the maturity time,

a SPeCs^{spot-}(seller) security which pays the nominal derivative security value if the underlying numerical variable fails to fall to a maturity value or less at the maturity time,

a SPeCs^{gen+}(seller) security which pays the nominal derivative security value if the underlying numerical variable fails to achieve a maturity value or more at any point in time from creation of the derivative security up to the maturity time, and

a SPeCs^{gen-} (seller) security which pays the nominal derivative security value if the underlying numerical variable fails to fall to a maturity value or less at any point in time from creation of the derivative security up to the maturity time.

As an example, one may consider a SPeCs derivative security that relates to stock of the company Shell which is listed on the London Stock Exchange (LSE).

| Underlying asset: | Shell |
|---|---|
| Stock Price at current date (1 Feb 06) | £5.45 |
| Predetermined future time | Close of trade of |
| (Maturity Time): | LSE on 1 Feb 07 |
| UK exchange listing code: | Shel |
| Price at predetermined future time | £7.00 |
| (Maturity Price): | |
| Nominal derivative security value | £1.00 |

Four possible SPeCs securities can exist in relation to Shell with a maturity price of £7.00 (i.e. a price above the current price):

(i) SPeCs^{spotShel+}(buyer)(Feb. 1, 2007): will pay £1 if the price of Shell achieves £7.00 or more at the maturity time that is close of trade of the LSE on 1 Feb. 2007;

(ii) SPeCs^{genShel+}(buyer)(Feb. 1, 2007): will pay £1 if the price of Shell achieves £7.00 or more at any point in time from creation of the derivative security up to the maturity time that is close of trade of the LSE on 1 Feb. 2007;

(iii) SPeCs^{spotShel+}(seller)(Feb. 1, 2007): will pay £1 if the price of Shell fails to achieve £7.00 or more at the maturity time that is close of trade of the LSE on 1 Feb. 2007; and

(iv) SPeCs^{genShel+}(seller)(Feb. 1, 2007): will pay £1 if the price of Shell fails to achieve £7.00 or more at any point in time from creation of the derivative security up to the maturity time that is close of trade of the LSE on 1 Feb. 2007;

In addition, it is possible to create derivative securities based on the Shell equity with a maturity price below the current price, for example at £5.00 based on this example. On the basis of the underlying equity data given above, it is possible to consider the following four SPeCs securities with a maturity price below the current price:

(i) SPeCs^{spotShel-}(buyer)(Feb. 1, 2007): will pay £1 if the price of Shell falls to £5.00 or less at the maturity time that is close of trade of the LSE on the 1 Feb. 2007;

(ii) SPeCs^{genShel-}(buyer)(Feb. 1, 2007): will pay £1 if the price of Shell falls to £5.00 or less at any point in time from creation of the derivative security up to the maturity time that is close of trade of the LSE on 1 Feb. 2007.

(iii) SPeCs^{spotShel-}(seller)(Feb. 1, 2007): will pay £1 if the price of Shell fails to fall to £5.00 or less at the maturity time that is close of trade of the LSE on 1 Feb. 2007; and

(iv) SPeCs^{genShel-}(seller)(Feb. 1, 2007): will pay £1 if the price of Shell fails to fall to £5.00 or less at any point in time from creation of the derivative security up to the maturity time that is close of trade of the LSE on 1 Feb. 2007.

As described herein, the traders are unconnected with the operator of the exchange. However, it is within the concept of the invention for the operator of the exchange to be one of the traders so that the exchange operator becomes a market maker for the derivative securities or for certain derivative securities. The exchange operator will in this case be acting as a seller, offering derivative securities at a given price or price range chosen by the exchange operator.

One form of computer system and trading method according to the invention will now be described by way of example with reference to the accompanying drawings in which:

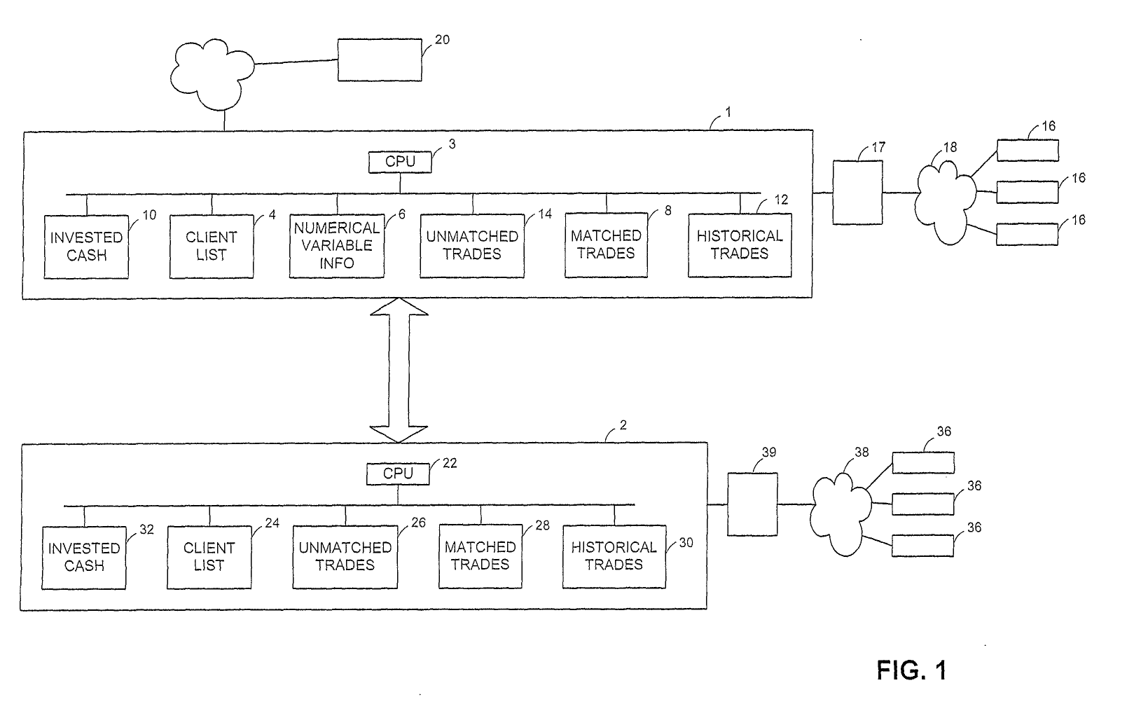

FIG. 1 is a schematic representation of a computer system according to the invention for creating and trading derivative securities;

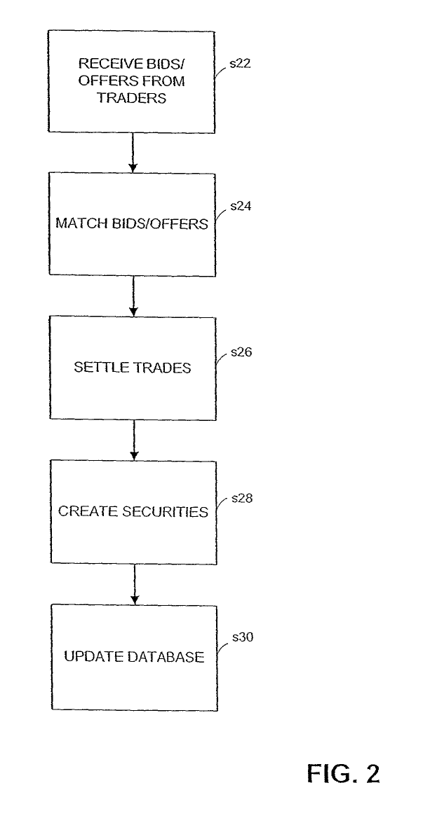

FIG. 2 is a flow diagram of the overall operation of the computer system when creating a derivative security;

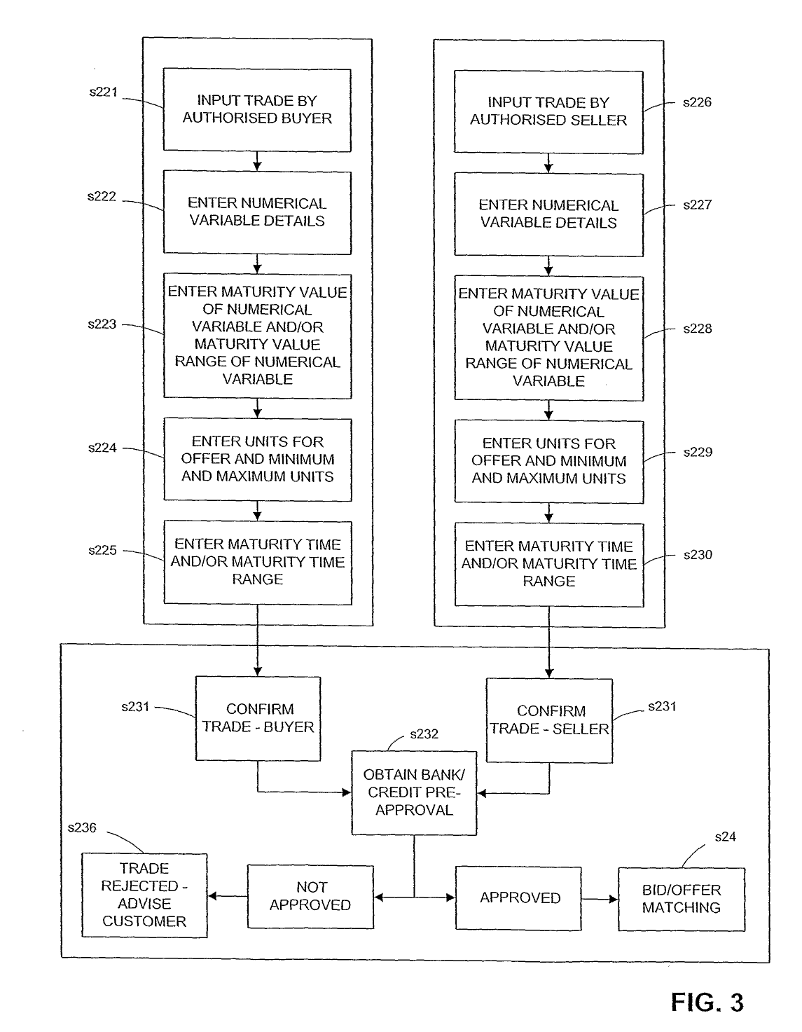

FIG. 3 is a flow diagram of the operations involved in initiating the system for receiving offers from traders;

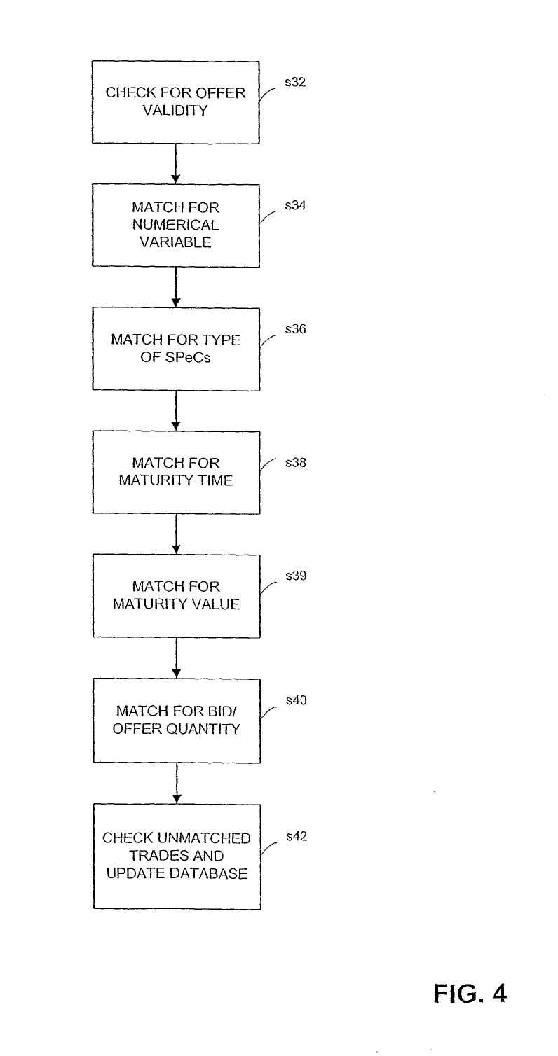

FIG. 4 is a flow diagram of the operation of the computer system when matching offers and bids of traders in the process of creating the derivative securities;

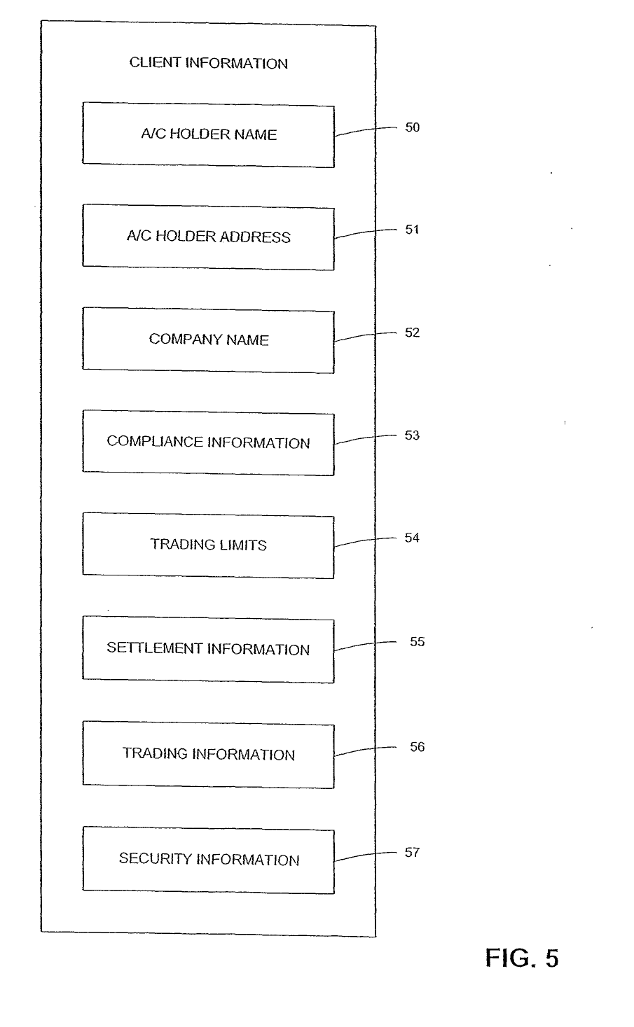

FIG. 5 shows information stored in the client database of the primary exchange;

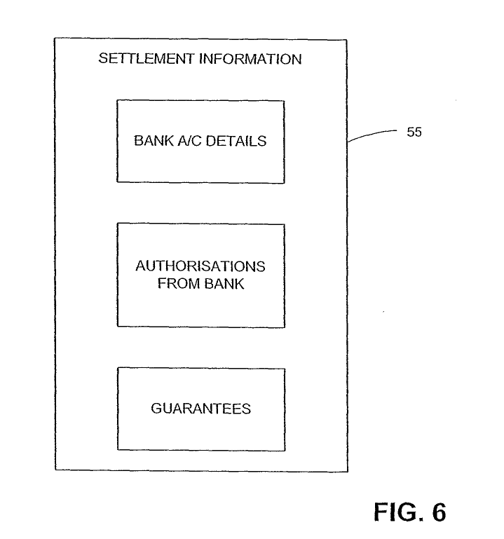

FIG. 6 is an example of information stored in the “Settlement Information” database of the client database of FIG. 5;

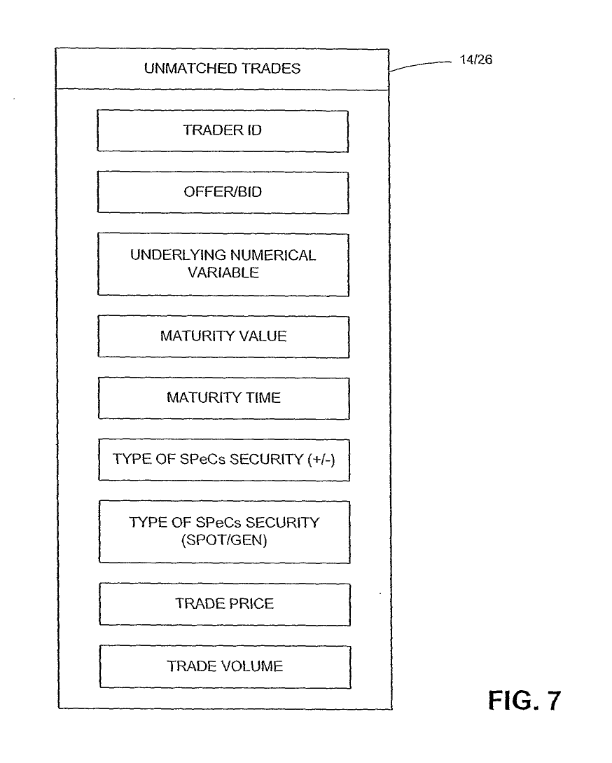

FIG. 7 shows information stored in the “Unmatched Trades” database;

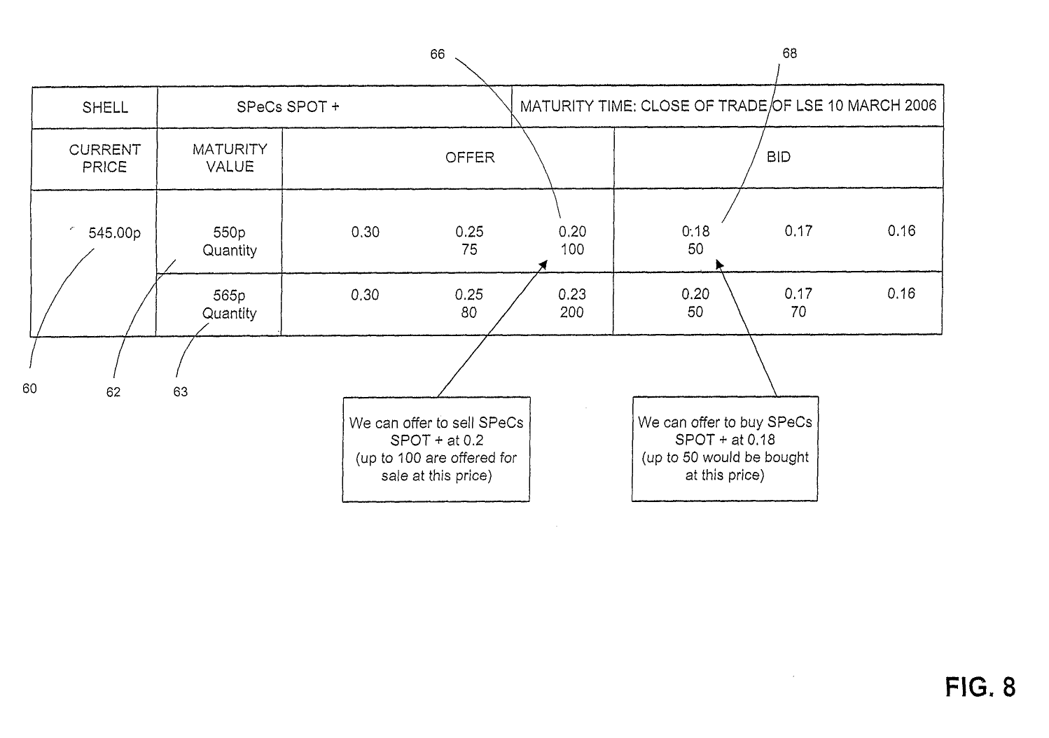

FIG. 8 is an example of a display which would be available to traders showing unmatched offers and bids in relation to a particular derivative security;

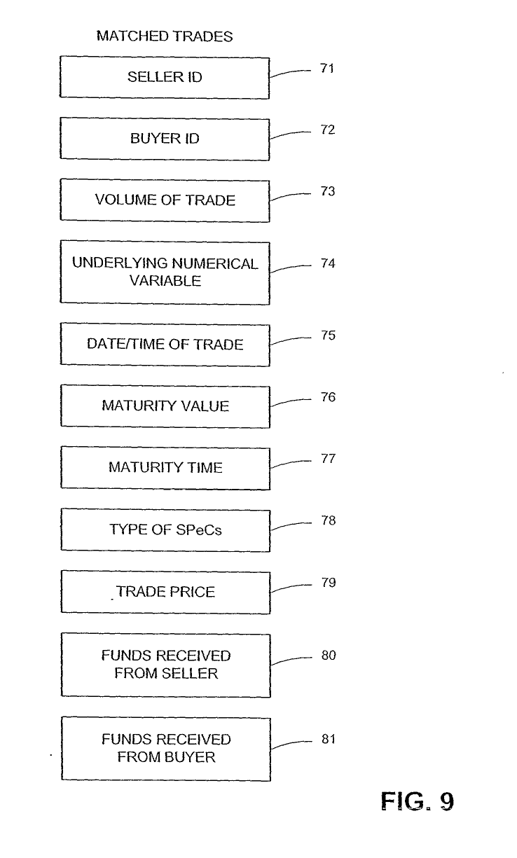

FIG. 9 shows information held in the “Matched Trades” database of the primary exchange;

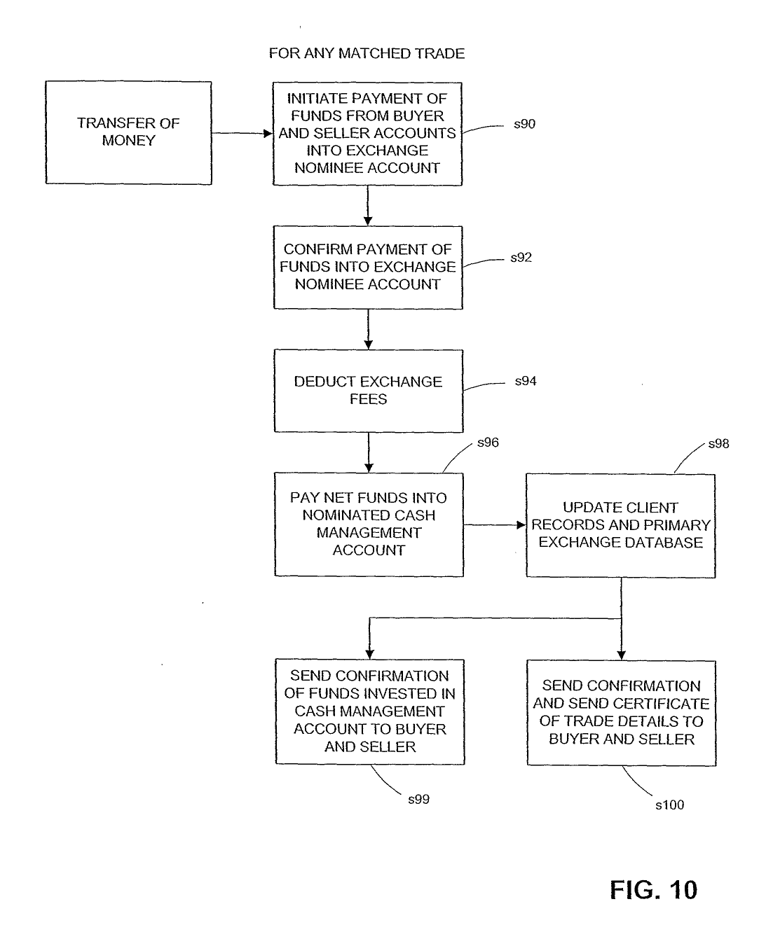

FIG. 10 is a flow diagram showing steps involved in the trade settlement process of the primary exchange;

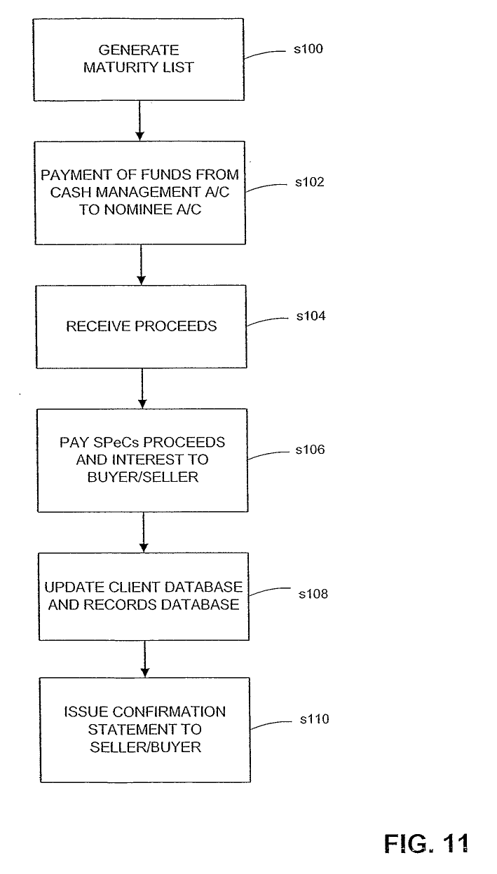

FIG. 11 is a flow diagram showing steps involved in settlement on maturity of a derivative security;

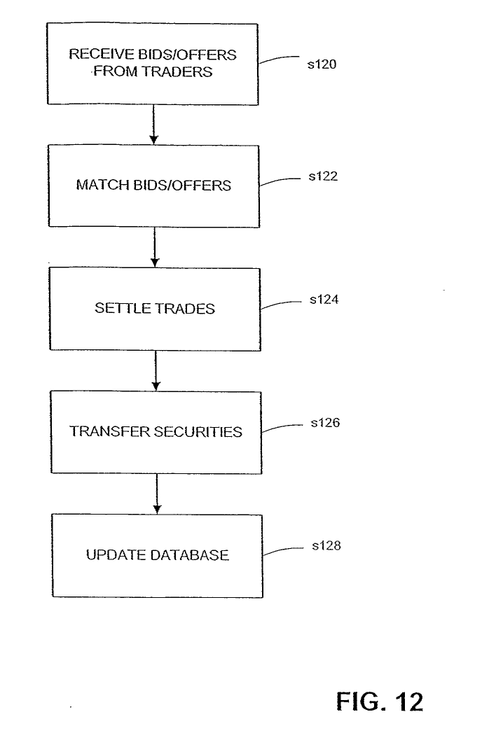

FIG. 12 is a flow diagram of the overall operation of the computer system forming the secondary exchange when trading existing derivative securities that have been created by the primary exchange; and

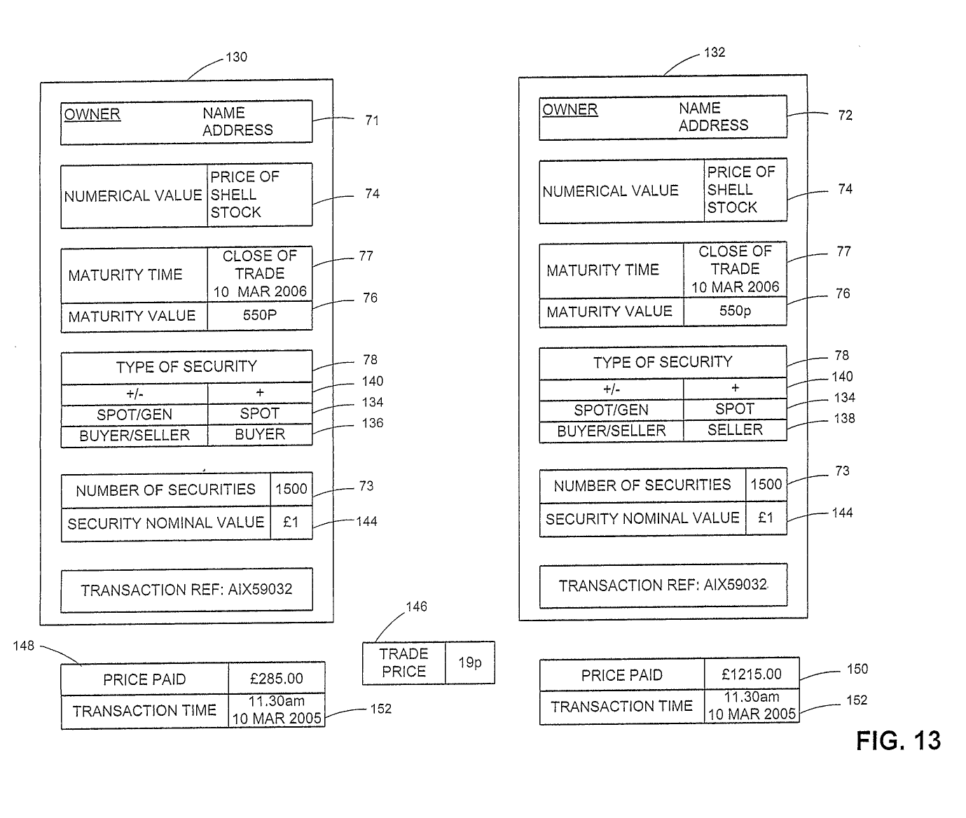

FIG. 13 is a schematic drawing of a pair of certificates of derivative securities created according to the invention, showing data that are required for the securities.

Referring to the accompanying drawings, FIG. 1 shows an exchange for creating and trading SPeCs securities according to the invention. The trading exchange comprises a computer system 1 that forms a primary exchange for matching bids and offers from different traders, and for creating the SPeCs securities, and a computer system 2 for trading in the derivative securities that have been created by the system 1. The primary exchange system comprises a computer, normally a server, having a central processing unit (CPU) 3 and memory, for example provided by RAM, ROM, optical or magnetic media or any other form of memory. In the memory a number of databases 4 to 14 may be stored relating to various aspects of the trading exchange, and the exchange can communicate with a number of traders (referred to as primary traders) 16 via a primary exchange communications server 17 and a network 18, for example a local area network (LAN), or a wide area network (WAN) and especially via the Internet. The primary exchange communications server may include any means for enabling communication with end-users and the web by wireless, voice-enabled, television, hand held devices, PCs, laptops, mobile telephones etc by appropriate protocols. All communications preferably comply with industry standard protocols ensuring secure connectivity and firewalls.

The server 1 can also communicate with other institutions 20 who are not using the server to trade in the securities, for example with financial institutions such as the various stock exchanges or bond, currency or commodities exchanges in order to receive general market information, for example information relating to asset or commodity prices. In the case of equity securities, asset prices will be real-time updated prices as traded on the respective stock exchanges, while for other forms of securities real time currency exchange rates, commodity prices etc will be required. Derivative information in relation to the assets that is available or made available to registered users of the exchanges may be received, for example, for equity securities, asset price analytics will include dividend yield, price to earnings ratio, free cash flow, underlying futures and option prices etc. For fixed income securities asset price analytics include information such as 5 year bond yields, underlying bond futures and options etc. In addition, the server will communicate with banks in order to deposit and retrieve funds on settlement of trades or on maturity of securities as explained below, and to investigate traders' creditworthiness. Yet other institutions may communicate with the server 1 as desired.

The memory of the server 1 will contain the following databases:

(i) Client Database 4

This database contains relevant information regarding a client that is required in order to ensure secure trading and access by the client; maintenance of confidentiality of all client records; and compliance with regulatory bodies and laws of the jurisdiction in which the exchange is trading.

The client database is shown in FIG. 5, and has a number of fields including fields containing the account holder's name 50 and address 51, and the company name 52, address and other relevant information such as authorizations in the case of companies. The database will also include compliance/regulatory information 53 as detailed by the regulatory bodies of the jurisdiction, and any trading limits 54 imposed on the trader. In addition, the client database will include fields for each trader containing security information 57, settlement information 55 and trading information 56.

The security information 57 will include passwords employed by the various traders and the password history, the user names of the traders and the setup information. This information will also include any additional protocol information required to enable secure trading by the client.

The settlement information 55 includes details of bank accounts where all transactions will be settled, authorizations from the client and from the client's bank, and any additional information that is required to be held to ensure settlement of transactions entered into by the client such as any guarantees from third parties. The database is shown in FIG. 6.

(ii) Numerical variable Information 6

This information will comprise the numerical variable value and analytics information e.g. p/e ratios for equities, dividend yield etc referred to above and obtained from various institutions 20 such as stock exchanges, weather centres, WHO etc.

(iii) Historical Trades 12

This information will include a detailed transaction level trading history, statements of account and any correspondence with the client.

(iv) Unmatched Trades 14

This database is shown in greater detail in FIG. 7, and includes all offers and bids from traders for the derivative securities for which no match has been found. Apart from data identifying the trader, the database contains data indicating whether the unmatched trade is an offer or a bid, the underlying numerical variable to which the trade relates, the type of derivative security, i.e. whether it is a “+” or “−” security, whether it is a “spot” or “gen” and whether it is a “buyer” or “seller” security, the trade price and the volume of securities specified in the bid or offer. This database is used to generate a webcast that can be accessed by traders of the exchange in order to decide how to bid. The trader identification field in the unmatched trades database is not used for generating the webcast, so that all traders remain anonymous. FIG. 8 shows part of one page of such a webcast. This page shows part of a page broadcast relating to SPeCs^{spot+} for underlying shares in Shell quoted on the LSE. The spot price for shell stock 60 is quoted as 545.00 pence in the left hand column, and various prices that are quoted by traders for purchase and for sale of the SPeCs securities with a maturity or horizon time of close of trade of the LSE on 10 Mar. 2006 are given. Each row 62, 63 of the page gives offers (offers to sell) and bids (offers to buy) for a SPeCs security having a different maturity price (i.e. share price of the underlying stock at the maturity or horizon time). Thus, cell 66 represents an offer (which may be made up of offers from many traders) to sell up to 100 securities at 20 pence each that will pay £1.00 each if the Shell stock rises to a value of 550.00 pence or more at close of trade of the LSE on 10 Mar. 2006, while cell 68 represents an offer to buy up to 50 SPeCs securities at 18 pence that will pay £1.00 each if the Shell stock rises to 550.00 pence or more at close of trade of the LSE on 10 Mar. 2006.

FIG. 8 shows only part of the trading screen in which bids and offers for four different types of derivative security (spot/gen or +/−) are displayed, and the screen can be scrolled either upwardly or downwardly to show offers and bids for each underlying numerical variable value at different maturity values and times, while the screen can be scrolled left to right to view different bid and offer prices for the same underlying numerical variable and maturity or horizon time. Each cell under the “OFFER” heading indicates the number of derivative securities at a given maturity value (either 550p or 565p) that are offered for sale at a given price. These offers may come from one or more traders. Similarly, under the heading “BID”, offers to buy derivative securities at different prices are shown. The price corresponding to the difference between the highest bid price and the lowest offer price may well represent the prices at which the bids and offers are matched.

(v) Matched Trades 8

This database includes all offers and bids for a SPeCs security that have been matched and for which a SPeCs has been created. Usually this database will contain information relating to the creation of the SPeCs security as shown in FIG. 9 which has been obtained from unmatched trades database 14 and some of which data has been generated by the decision unit when the trades were matched. This information includes the names and identification 71, 72 of the parties to the trade and any authentication information, the number 73 of SPeCs created, information 74 identifying the underlying numerical variable, the date (or time within the day if appropriate) of the trade 75, the maturity or horizon value 76, the maturity or horizon time 77, the type of SPeCs 78 (for example whether it is a SPeCs^{spot+}(buyer), SPeCs^{spot-}(buyer), SPeCs^{gen+}(buyer), SPeCs^{gen-}(buyer), SPeCs^{spot+}(seller), SPeCs^{spot-}(seller), SPeCs^{gen+}(seller) or SPeCs^{gen-}(seller)). The information also includes the trade price 79 or price that was agreed by the traders when the match was made, and the total funds received from the seller 80 and from the buyer 81. This information is necessary in order to reimburse the relevant party when the SPeCs security matures or when the security is sold.

(viii) Invested Cash 10

This database is a record of all funds that have been received by the traders when the SPeCs security is created and which have been deposited.

Creation of Securities

FIG. 2 is a flow diagram of the steps conducted by the primary exchange when a SPeCs security is created. Before any trading can commence, it is necessary for a client to open a trading account with the exchange 1 so that the client's name and identification are entered on the client list 4. This information is necessary to ensure secure trading and access by the client, to ensure confidentiality of client records is maintained and that all activities are in compliance with regulatory bodies and relevant legislation.

Once a client account has been set up, the client can begin to trade. During trading the exchange or server 1 will receive bids and offers from different traders S22, and on receipt of the various bids and offers, the exchange 1 attempts to match the two. FIG. 3 is a flow diagram showing the steps undertaken by the traders of the primary exchange in the initial process of making offers. In step S221 the buyer inputs the type of derivative security (e.g. whether the trade is for a spot or gen, a + or −, or a buyer or seller derivative security) for which a bid will be placed in the exchange on an input screen that is validated by the exchange. The buyer then enters details of the underlying numerical variable on which the SPeCs will be traded (step S222) and this is validated by the exchange. After validation, the buyer enters the maturity or horizon value of the numerical variable and/or the maturity or horizon value range of the numerical variable for which he/she is prepared to buy (step S223) and will then enter the number of units that he/she is willing to offer to buy at that price (step S224). It is not necessary to enter a precise number of units: it is possible to enter a maximum number of units and, if desired also a minimum number of units he/she is prepared to buy. Then, a maturity or horizon time is entered, or alternatively he/she may enter a time range for the horizon time, for example from 1 to 6 months for which he/she is prepared to buy the derivative securities.

Independently, a seller will enter corresponding details of derivative securities that he/she is prepared to sell (steps S226 to S230) in the same way as the buyer. Once a trader, whether a buyer or a seller, has entered details of the securities he/she wishes to trade in, the exchange requests confirmation (step S231) and, on receipt of confirmation, the exchange obtains bank/credit pre-approval, if appropriate, in order to ensure that the trader has available funds to settle the trade (step S232). Approval is either not received in which case the trader is notified of that fact (step S236), or it is received in which case the exchange attempts to match the bid and offer (step S24).

This process is shown in FIG. 4 which is a flow chart of the bid/offer matching process step S24. The primary exchange processing engine will first check the offers for valid maturity times and other data (step S32) and will attempt to match the underlying numerical variable details of the SPeCs which will, where the numerical variable is the price of stock, be represented by the underlying securities unique International Securities Identification Number (ISIN) step (S34). After matching the underlying numerical variable details the exchange will attempt to match the type of derivative security (step S36) to which the bid or offer relates, for example as to whether it is a SPeCs^{spot} or a SPeCs^{gen} security, and whether it is a + or − security. The exchange then attempts to match the maturity or horizon time or time range (step S38) and to match the maturity or horizon value of the numerical variable or value range of the numerical variable (step S39). Where a time and/or value range is specified by one or both of the traders, it is necessary to specify the relevant parameter or parameters with precision in the matching operation. For example, where a numerical variable value range or a maturity time range has been specified by only one of the traders and a precise numerical variable value or maturity time has been specified by the other trader, the computer may match the bid and offer by specifying the precise numerical variable value or maturity time. Where, however, both traders have specified a range, some further algorithm is necessary to specify the parameter precisely. For example, the computer may determine the range of overlap between the two ranges, and then determine some point within the ranges, for example a mid-point, as being the agreed value between the two traders. Alternatively, an end point, such as the earliest time in a time range may be chosen. It will be appreciated that the particular algorithm is not important provided that it is consistent and that all traders are aware of it. Finally, the exchange or server 1 attempts to match the quantity of derivative securities that are available for bid/offer (step S40). Where a complete quantity of derivative securities is not matched, then at the option of the buyer and seller a partial quantity may be matched. The exchange may have a minimum lot size (for example 100) that will be made available for trading with increments at discrete intervals.

Of course, since a match only occurs if all the criteria are matched, the order in which the above steps are conducted may be altered.

Finally, all unmatched trades are checked (step S42) on a continuous basis for valid offer times and the unmatched trades database 14 is updated before the unmatched trades data is broadcast on the web.

Once all the trades have been matched in all respects (step S24) the trades can be settled in real time (step S26). This is shown in FIG. 10 and involves initiation of payment of funds from the traders' nominated accounts into the exchange's nominee accounts (step S90) and sending confirmation to the traders (step S92). These funds, net of transaction costs levied by the exchange (step S94) as explained above, will then be invested in a secure fund cash management account until maturity of the SPeCs (step S96). Interest on the funds invested, minus any administration fee levied by the exchange, will be accrued and paid to the traders, normally in proportion to funds they have paid. For example, for a SPeCs security of price p pence that will pay £1.00 at maturity (depending on the value of the underlying numerical variable) the buyer will be debited p pence per derivative security while the seller will be debited £(1.00-p) on matching. The client records database is updated at step S98. Confirmation of investment of the funds in the cash account is sent to the traders at step S99 and confirmation and certificates may then be sent to the traders (step S100). These steps are shown in FIG. 10. Where a buyer's or seller's trades are fully hedged and there is no risk to the exchange, surplus funds may be released at the request of the buyer or seller.

Upon settlement of the trade, the derivative securities will be created (step S28) by a process comprising sending confirmation of creation of the derivative securities to both parties, one “buyer” security and one “seller” security. Certificates will be sent to the parties as soon as convenient. The derivative securities may be issued in electronic format. For example, securities based on underlying equities may be similar to electronic stock certificates recording details of ownership. FIG. 13 is a schematic drawing showing a pair of certificates 130 and 132 that have been generated in respect of a single trade, and shows the information that will be held in the primary exchange computer database that defines the derivative security created by the trade. As a minimum, the certificate will normally record the name or other identification of the underlying numerical variable 74, the type of derivative security 78 (i.e. whether spot or general 134, buyer 136 or seller 138 and whether + or −140), the maturity or horizon value 76 of the numerical variable, the maturity time 77, and the number 73 of derivative securities forming the trade, and the nominal value 144 of the derivative security. Although the owner 71 or 72 will be identified on the certificate, it is not necessary or desirable to record the other party to the trade. Information regarding the other party is irrelevant since the funds relating to creation of the derivative security have been invested in a secure fund. The matched trades database and the historical trades database may then be updated to reflect the creation of the derivative security, and after some defined period of time following creation of the securities the webcast of the exchange is updated to show details of the derivative security. These details may also be available through other financial information suppliers. Normally details of the derivative security will be made available in the webcast the day following creation of the derivative security although other timescales may be adopted.

In addition to information required for the certificates, FIG. 13 shows other data recorded in the relevant exchange database but not necessarily shown on the certificates, including the trade price 146, the total price paid by the buyer 148 and by the seller 150, and the transaction date and/or time 152.

Maturity of Securities

FIG. 11 is a flow diagram showing the process for paying funds on maturity of derivative securities. After creation of the derivative securities, a maturity list will be generated (step S100) by the primary exchange that will initiate payment on maturity of the derivative securities. The condition that initiates maturity of the derivative security will depend on the type of derivative security, for example, a SPeCs^{spot} maturity list will initiate maturity of the derivative security at a predetermined time, while a SPeCs^{gen} maturity list will initiate maturity of the derivative security if the numerical variable has risen to or above or fallen to or fallen below a given value before the maturity or horizon time or at the maturity or horizon time (depending on the type of derivative security). The maturity list will commence transfer of funds from the cash management account to the exchange nominee account (steps S102 and S104) which are then paid to the buyer or to the seller depending on the type of derivative security and whether or not the conditions for payment have been met (step S106). In addition any interest that has accrued on the sums paid initially is also paid to both the buyer and the seller (net of any administration fees levied by the exchange). The client database will be updated to record maturity of the derivative security and a maturity statement is issued recording the final value of the derivative security and confirmation is sent to the buyer and seller (step S110).

Secondary Exchange

The derivative securities created according to the invention may also be traded during their period of currency. For the purpose of trading in the derivative securities, a secondary exchange 2 as shown in FIG. 1 may be created. The secondary exchange 2 is preferably associated with the primary exchange 1 and may exchange relevant information with the primary exchange in order to facilitate trading. Like the primary exchange, the secondary exchange may comprise a computer having a central processing unit 22 that communicates with memory, for example RAM, ROM, optical or magnetic media or any other form of memory, in which databases 24 to 32 are stored. The computer forming the secondary exchange 2 may communicate with a number of traders 36 (referred to as secondary traders) via a network 38, for example a local area network (LAN), or a wide area network (WAN), and especially via the Internet, the secondary exchange communicating with the network 38 by means of a secondary exchange communications server 39. As with the primary exchange, the secondary exchange communications server may communicate with the end-users 36 and the web by wireless, voice-enabled, television, hand held devices, PCs, laptops, mobile telephones etc by appropriate protocols.

The databases in the memory of the computer forming the secondary exchange 2 are generally the same as the databases in the primary exchange 1, namely the client database 24 which includes client information as shown in FIG. 5 in order to enable the client to pay and receive funds, (account holder name and address, company name, approved authorisation, compliance/regulatory information, settlement information, trading limits of the client and security information). Security information 57 includes passwords, password history, username and setup information, and any additional information required to enable secure trading. The secondary exchange may also include a historical trades database that includes a detailed transaction trading history, statements of account and any correspondence with the relevant secondary trader. As in the primary exchange, the secondary exchange may include an unmatched trades database 26 but in the case of the secondary exchange, this database contains details of all existing SPeCs securities that have been offered for sale and/or offered for purchase by traders.

Secondary Exchange Trading

The operation of the secondary exchange is similar to that of the primary exchange, and will not be described in detail where the process steps of the secondary exchange are the same as those of the primary exchange 1.

Trading on the secondary exchange 2 is as shown in FIG. 12 (steps S120 to S128). This process is generally the same as the process for trading in the primary exchange as shown in FIG. 2 with the exception that the securities are transferred from the seller to the buyer in step S126 rather than being created. The initial part of the trading is the receipt of bids/offers from traders (step S120) which is exactly the same as the corresponding receipt of bids and offers as shown in FIG. 3 in the primary exchange with the addition that the traders will need to specify whether the derivative security is a buyer or seller security. The bids and offers may be displayed on a screen generally as shown in FIG. 8 in respect of the primary exchange with the exception that eight different types of derivative security (spot/gen, +/−, buyer/seller) will be displayed. A further difference between the confirmation and approval steps in the primary exchange (steps S231 and S232) is that it may not be necessary in all circumstances for the secondary exchange to obtain bank/credit pre-approval from the seller since he will only be receiving funds from the buyer.

In addition to receiving offers/bids from the traders, the secondary exchange processing engine will verify from the derivative security and settlement databases of the primary exchange that the seller is the authorised holder of the relevant derivative security and that the number of derivative securities offered for sale agrees with the seller records (i.e. that the seller holds at least the number of derivative securities that are offered for sale).

The process then proceeds to bid/offer matching (step S122). This step is essentially the same as the bid/offer matching step conducted by the primary exchange for creation of the derivative securities as shown in FIG. 4: the exchange checks for validity of the offer, matches the underlying numerical variable, the type of derivative security and the maturity time and the trade price, and attempts to match for the quantity of derivative securities, or to achieve a partial match for quantity. The trades are then settled and payment of funds will be initiated. Funds are paid from the buyers' to the sellers' nominated accounts (net of transaction costs), and the derivative securities are then transferred by cancelling the seller's ownership for the quantity sold and registering that quantity in the name of the buyer. Each trader will be sent confirmation, the secondary exchange and client databases are then updated together with the matched trades database, and the relevant information is sent to the secondary exchange webcast.

1. A computer system that constitutes a primary exchange for creating derivative securities that secure a claim of a predetermined nominal derivative security value that is contingent on a well defined, externally influenced numerical variable associated therewith at or before a predetermined future time, which system comprises:
(a) a database for storing data defining purchase offers and offers of sale of the derivative securities received from traders, whether buyers or sellers, the database being structured for storing records for each offer including
(i) the identity of a trader that has made the offer,
(ii) data indicating whether the offer is a purchase offer or offer for sale,
(iii) the identity of the numerical variable,
(iv) numbers representing the price offered by a buyer (the bid price) or the price offered by a seller (the offer price),
(v) numbers representing the predetermined future time,
(vi) numbers representing a value of the numerical variable at the predetermined future time or before the predetermined future time that is defined in the offer,
(vii) data indicating the relationship between the defined value of the numerical variable at or before the predetermined future time specified in the offer and the actual value of the numerical variable at or before the predetermined future time that is required in order for the trader to secure the claim,
(viii) numbers representing the quantity of derivative securities in the offer;
(b) an input for receiving the data defining the purchase offers from buyers;
(c) an input for receiving the data defining offers of sale from sellers;
(d) a decision unit for determining whether or not a match exists between a purchase offer and an offer of sale in the database in terms of:
(i) the bid and offer prices, referred to as the agreed trade price if a match is determined,
(ii) the numerical variable,
(iii) the predetermined future time,
(iv) the defined value of the numerical variable at the predetermined future time specified in the offer, and
(v) the relationship between the defined value of the numerical variable specified in the offer and the actual value of the numerical variable at the predetermined future time or at a time up to the predetermined future time; and
(e) a derivative security creation module that is responsive to output from the decision unit that a match exists in order to create one or more derivative securities, which comprises:
(i) a trade settlement unit for automatically calculating the agreed number of the derivative securities, being the maximum number of derivative securities that are the subject of both the purchase offer and the offer of sale; calculating the maximum financial obligation of a trader, being substantially the product of the agreed number of derivative securities and the agreed trade price of the derivative securities if the trader is a buyer, or substantially the product of the agreed number of derivative securities and the difference between the nominal derivative security value and the agreed trade price if the trader is a seller; automatically receiving funds from traders corresponding to their maximum financial obligation; and
(ii) a derivative security creation unit for notifying the traders of creation of the derivative security and of data relating to the derivative security, and storing data relating to the derivative security in a database; and
(f) a maturity settlement module for paying appropriate traders at the predetermined future time or before the predetermined future time depending on the type of derivative security, which comprises:
(i) a maturity data input module for receiving from an external source data quoted by an independent institution representing the actual value of the numerical variable at the predetermined future time or before the predetermined future time;
(ii) a determination module responsive to data from the maturity data input module, for determining, at the predetermined future time or before the predetermined future time, whether the actual value of the numerical variable is the same as or is above or below the defined value specified in the offer;
(iii) a reimbursement module responsive to data from the determination module, for sending to one of the traders or to an agreed third party funds corresponding substantially to the product of the agreed number of the securities and the nominal derivative security value.

2. A computer system as claimed in claim 1, which includes quoted value input means for receiving from one or more external sources values of numerical variables quoted by an independent institution.

3. A computer system as claimed in claim 1, which includes means for publishing at least some offers from traders for which no matches have been determined by the decision unit.

4. A computer system as claimed in claim 2, which includes a publishing unit for publishing information relating to the numerical variables.

5. A computer system as claimed in claim 1, which includes a publishing unit for publishing information relating to the matched trades.

6. A computer system as claimed in claim 1, which is operative to create different types of derivative security, some of which generate the right and obligation of payment if the value of the numerical variable rises to or above, or falls to or below the defined value at or before the predetermined time, and some of which generate the right and obligation of payment if the numerical variable rises to or above, or falls to or below, respectively the defined value at the predetermined time.

7. A computer system as claimed in claim 1, wherein, if the decision unit determines that a match exists, the derivative security creation module is operative to create (a) a “buyer” derivative security that will pay the predetermined nominal derivative security value if, at or before the predetermined future time, the numerical variable rises to or above, or falls to or below, the defined value of the numerical variable, and (b) a “seller” derivative security that will pay the predetermined nominal derivative security value if, at the same time, the value of the numerical variable fails to rise to or above or fails to fall to or below, respectively, the defined value of the numerical variable, two such derivative securities being created, one in the name of each of the traders that have been matched by the decision unit.

8. A computer system as claimed in claim 1, wherein the determination module is operative to determine whether the actual value of the numerical variable is the same as or is above or below the defined value specified in the offer at the predetermined future time.

9. A computer system as claimed in claim 1, wherein the determination means is operative to determine whether or not the actual value of the numerical variable at the predetermined future time or before the predetermined future time is the same as or is above the defined value specified in the offer.

10. A computer system as claimed in claim 1, which is arranged to receive funds automatically from each of the traders or an agreed third party at the time the trade settlement unit creates the derivative security, and to deposit the funds in a secure account.

11. A computer system as claimed in claim 10, wherein the reimbursement module is operative to pay any trader that is owed money out of funds that have been deposited in the secure account.

12. A computer system as claimed in claim 1, wherein the database stores numbers representing the nominal value of derivative securities created thereby.

13. A computer system as claimed in claim 1, which also constitutes a secondary exchange for trading existing derivative securities that have been created by the primary exchange.

14. A computer system as claimed in claim 13, which includes:
(g) a secondary input for receiving purchase offers from traders to buy the existing derivative securities;
(h) a secondary input for receiving offers of sale of the existing derivative securities from traders;
(i) a database for storing the offers to buy and offers to sell;
(j) a secondary decision unit for determining whether or not a match exists between an offer to buy and an offer for sale of an existing derivative security created by the primary exchange in the database in terms of the bid and offer prices of the existing derivative security, the type of derivative security, the numerical variable and the predetermined future time; and
(k) a secondary trade settlement unit, responsive to an output from the secondary decision unit that a match exists, for automatically calculating the agreed number of existing derivative securities that are traded in the secondary exchange being the maximum number of existing derivative securities that are the subject of both an offer to buy and an offer for sale; calculating the financial obligation of a trader who has made an offer to buy the existing derivative security and for automatically receiving funds from that trader, updating databases of the trade if the secondary decision unit determines that a match exists; and notifying the traders of transfer of the derivative security from the seller to the buyer.

15. A computer system that constitutes a secondary exchange for trading existing derivative securities which includes:
(g) a secondary input for receiving purchase offers from traders to buy the existing derivative securities;
(h) a secondary input for receiving offers of sale of the existing derivative securities from traders;
(i) a database for storing the offers to buy and offers to sell;
(j) a secondary decision unit for determining whether or not a match exists between an offer to buy and an offer for sale of an existing derivative security created by the primary exchange in the database in terms of the bid and offer prices of the existing derivative security, the type of derivative security, the numerical variable and the predetermined future time; and
(k) a secondary trade settlement unit, responsive to an output from the secondary decision unit that a match exists, for automatically calculating the agreed number of existing derivative securities that are traded in the secondary exchange being the maximum number of existing derivative securities that are the subject of both an offer to buy and an offer for sale; calculating the financial obligation of a trader who has made an offer to buy the existing derivative security and for automatically receiving funds from that trader, updating databases of the trade if the secondary decision unit determines that a match exists; and notifying the traders of transfer of the derivative security from the seller to the buyer.

16. A computer system as claimed in claim 13, which is arranged to forward funds automatically to an account in the name of the seller of the existing derivative security or an agreed third party in respect of the purchase of the derivative security by the buyer.

17. a method of operating a computer system that constitutes a primary exchange for creating derivative securities that secure a claim of a predetermined nominal derivative security value that is contingent on a well defined, externally influenced numerical variable associated therewith at or before a predetermined future time, which method comprises the steps of:
(a) receiving data defining the purchase offers from buyers;
(b) receiving data defining offers of sale from sellers;
(c) storing the data defining purchase offers and offers of sale of the derivative securities received from traders, whether buyers or sellers, in a database, the database being structured for storing records for each offer including
(i) the identity of a trader that has made the offer,
(ii) data indicating whether the offer is a purchase offer or offer for sale,
(iii) the identity of the numerical variable,
(iv) numbers representing the price offered by a buyer (the bid price) or the price offered by a seller (the offer price),
(v) numbers representing the predetermined future time,
(vi) numbers representing a value of the numerical variable at the predetermined future time or before the predetermined future time that is defined in the offer,
(vii) data indicating the relationship between the defined value of the numerical variable at or before the predetermined future time specified in the offer and the actual value of the numerical variable at or before the future time that is required in order for the trader to secure the claim,
(viii) numbers representing the quantity of derivative securities in the offer;
(d) determining whether or not a match exists between a purchase offer and an offer of sale in the database in terms of:
(i) the bid and offer prices, referred to as the agreed trade price if a match is determined,
(ii) the numerical variable,
(iii) the predetermined future time,
(iv) the defined value of the numerical variable at the future time specified in the offer, and
(v) the relationship between the defined value of the numerical variable at the predetermined future time or before the predetermined future time specified in the offer and the actual value of the numerical variable at the future time or at a time up to the future time that is required in order for the trader to secure the claim; and
(e) creating a derivative security in response to output from the determining step that a match exists, which step comprises:
(i) automatically calculating the agreed number of the derivative securities, being the maximum number of derivative securities that are the subject of both the purchase offer and the offer of sale; calculating the maximum financial obligation of a trader, being substantially the product of the agreed number of derivative securities and the agreed trade price of the derivative securities if the trader is a buyer, or substantially the product of the agreed number of derivative securities and the difference between the nominal derivative security value and the agreed trade price if the trader is a seller; automatically receiving funds from traders corresponding to their maximum financial obligation; and
(ii) notifying the traders of creation of the derivative security and of data relating to the derivative security, and storing data relating to the derivative security in a database; and
(f) a maturity settlement step for paying appropriate traders at the predetermined future time or before the predetermined future time depending on the type of derivative security, which comprises:
(i) a maturity data input step of receiving from an external source data quoted by an independent institution, representing the actual value of the numerical variable at the predetermined future time or before the predetermined future time;
(ii) a determination step, of determining in response to data from the maturity data input step, at or before the predetermined future time, whether the actual value of the numerical variable is the same as or is above or below the defined value specified in the offer;
(iii) a reimbursement step of sending to one of the traders or to an agreed third party, funds corresponding substantially to the product of the agreed number of the derivative securities and the nominal derivative security value, in response to data from the determination step.

18. A method as claimed in claim 17, which includes a quoted value input step for receiving from one or more external sources values of numerical variables quoted by the independent institution.

19. A method as claimed in claim 17, which includes the step of publishing at least some offers from traders for which no matches have been determined

20. A method as claimed in claim 17, which includes a step of publishing information relating to the numerical variables.

21. A method as claimed in claim 17, which includes the step of publishing information relating to the matched trades.

22. A method as claimed in claim 17, which is operative to create different types of derivative security, some of which give the right to, and obligation of, payment if the value of the numerical variable rises to or above, or falls to or below, the defined value at or before the predetermined time, and some of which generate the right to and obligation of, payment if the value of the numerical variable rises to or above, or falls to or below, the defined value at the predetermined time.

23. A method as claimed in claim 17, wherein, if it is determined that a match exists, two securities are created, namely: (a) a “buyer” derivative security that will pay the predetermined nominal derivative security value if, at or before the predetermined future time, the numerical variable rises to or above, or falls to or below, the defined numerical variable value, and (b) a “seller” derivative security that will pay the predetermined nominal derivative security value if at the same time the numerical variable fails to rise to or above or fails to fall to or below, respectively the defined numerical variable value, two such derivative securities being created, one in the name of each of the traders that have been matched in the determining step.

24. A method as claimed in claim 17, which includes receiving funds automatically from each of the traders or from an agreed third party at the time the derivative security is created, and depositing the funds in a secure account.

25. A method as claimed in claim 24, wherein any trader that is owed money or an agreed third party is paid in the reimbursement step out of funds that have been deposited in the secure account.

26. A method as claimed in claim 17, which includes trading existing securities that have been created by the primary exchange.

27. A method as claimed in claim 26, which includes:
(g) receiving purchase offers from traders to buy the existing derivative securities;
(h) receiving offers of sale of the existing derivative securities from traders;
(i) storing the offers to buy and offers to sell in a database;
(j) a secondary decision step of determining whether or not a match exists between a purchase offer and an offer for sale of an existing derivative security in the database in terms of the bid and offer prices of the existing derivative security, the type of derivative security, the numerical variable and the predetermined future time; and
(k) a secondary trade settlement step, responsive to output from the secondary decision step that a match exists, of automatically receiving funds from a trader who has made an offer to buy the existing derivative security or from an agreed third party, notifying the traders of transfer of the derivative security from the seller to the buyer, and updating databases of the trade if it is determined that a match exists in the secondary decision step.

28. A method of operating a computer system that constitutes a secondary exchange for trading derivative securities, which comprises:
(g) receiving purchase offers from traders to buy the existing derivative securities;
(h) receiving offers of sale of the existing derivative securities from traders;
(i) storing the offers to buy and offers to sell in a database;
(j) a secondary decision step of determining whether or not a match exists between a purchase offer and an offer for sale of an existing derivative security in the database in terms of the bid and offer prices of the existing derivative security, the type of derivative security, the numerical variable and the predetermined future time; and
(k) a secondary trade settlement step, responsive to output from the secondary decision step that a match exists, of automatically receiving funds from a trader who has made an offer to buy the existing derivative security or from an agreed third party, notifying the traders of transfer of the derivative security from the seller to the buyer, and updating databases of the trade if it is determined that a match exists in the secondary decision step.

29. A method as claimed in claim 27, which is arranged to forward funds automatically to an account in the name of the seller or an agreed third party in respect of purchase of the derivative security by the buyer.

30. A tradable derivative security, which comprises a legally binding right of an owner thereof to receive a predetermined sum of money, constituting a nominal derivative security value, in a circumstance that the value of a numerical variable associated with the derivative security determined by an independent institution rises to or above, or falls to or below, a defined value or fails to rise to or above or fails to fall to or below the defined value, at a predetermined future time or before a predetermined future time, the nominal derivative security value having been deposited in a secure account and received from the owner together with funds from another trader who had agreed with the owner that the owner would receive the nominal derivative security value in the said circumstance and that the other trader would receive the nominal derivative security value in any other circumstance.

31. A tradable derivative security as claimed in claim 30, wherein the nominal derivative security value has been deposited in the secure account by the owner and by the other trader in proportions that have been determined by trading on an exchange.

32. A tradable derivative security which comprises a legally binding right of an owner thereof to receive a predetermined sum of money, constituting the nominal derivative security value, in a circumstance that the value of a numerical variable associated with the derivative security determined by an independent institution rises to or above or falls to or below, a defined value, or fails to rise to or above or fails to fall to or below the defined value, at a predetermined future time or before a predetermined future time, the derivative security comprising data stored in a database of a derivative security exchange which defines:
(i) the identity of the owner
(ii) the identity of the numerical variable,
(iii) the predetermined future time,
(iv) the defined value of the numerical variable;
(v) the relationship between the defined value of the numerical variable at or before the future time specified in the derivative security and the actual value of the numerical variable at or before the future time that is required in order for the owner to secure the claim; and
(vi) data identifying funds held in a secure account that were used to purchase the derivative security.

33. A derivative security as claimed in claim 32, wherein the owner has a legally binding right to receive the nominal derivative security value in the circumstance that, at or before the predetermined future time, the numerical variable value rises to or above or falls to or below the defined numerical variable value.

34. A derivative security as claimed in claim 32, wherein the owner has a legally binding right to receive the nominal derivative security value in the circumstance that, at or before the predetermined future time, the numerical variable value fails to rise to or above or fails to fall to or below the defined numerical variable value.

35. A derivative security as claimed in claim 30, wherein the predetermined sum of money is a currency unit or a fraction or multiple thereof.

36. A carrier which carries a computer program comprising processor-implementable instructions for causing a computer to constitute a primary exchange for creating derivative securities that secure a claim of a predetermined nominal derivative security value that is contingent on a well defined, externally influenced numerical variable associated therewith at or before a predetermined future time, which program comprises:
(a) code for generating a database in the computer memory for storing data defining purchase offers and offers of sale of the derivative securities received from traders, whether buyers or sellers, the database being structured for storing records for each offer including
(i) the identity of a trader that has made the offer,
(ii) data indicating whether the offer is a purchase offer or offer for sale,
(iii) the identity of the numerical variable,
(iv) numbers representing the price offered by a buyer (the bid price) or the price offered by a seller (the offer price),
(v) numbers representing the predetermined future time,
(vi) numbers representing a value of the numerical variable at the predetermined future time or before the predetermined future time that is defined in the offer,
(vii) data indicating the relationship between the defined value of the numerical variable at or before the predetermined future time specified in the offer and the actual value of the numerical variable at or before the predetermined future time that is required in order for the trader to secure the claim,
(viii) numbers representing the quantity of derivative securities in the offer;
(b) code for receiving the data defining the purchase offers from buyers;
(c) code for receiving the data defining offers of sale from sellers;
(d) code for determining whether or not a match exists between a purchase offer and an offer of sale in the database in terms of:
(i) the bid and offer prices, referred to as the agreed trade price if a match is determined,
(ii) the numerical variable,
(iii) the predetermined future time,
(iv) the defined value of the numerical variable at the predetermined future time specified in the offer, and
(v) the relationship between the defined value of the numerical variable specified in the offer and the actual value of the numerical variable at the predetermined future time or at a time up to the predetermined future time; and
(e) code for creating a derivative security in response to output from the determining step that a match exists in order to create one or more derivative securities, which comprises:
(i) code for a trade settlement step of automatically calculating the agreed number of the derivative securities, being the maximum number of derivative securities that are the subject of both the purchase offer and the offer of sale; calculating the maximum financial obligation of a trader, being substantially the product of the agreed number of derivative securities and the agreed trade price of the derivative securities if the trader is a buyer, or substantially the product of the agreed number of derivative securities and the difference between the nominal derivative security value and the agreed trade price if the trader is a seller; automatically receiving funds from traders corresponding to their maximum financial obligation; and
(ii) code for a derivative security creation step of notifying the traders of creation of the derivative security and of data relating to the derivative security, and storing data relating to the derivative security in a database; and
(f) code for a maturity settlement step of paying appropriate traders at the predetermined future time or before the predetermined future time depending on the type of derivative security, which comprises:
(i) code for a maturity data input step of receiving from an external source data quoted by an independent institution representing the actual value of the numerical variable at the predetermined future time or before the predetermined future time;
(ii) code for a determination step responsive to data from the maturity data input step, of determining, at the predetermined future time or before the predetermined future time, whether the actual value of the numerical variable is the same as or is above or below the defined value specified in the offer;
(iii) code for a reimbursement step responsive to data from the determination step, for sending to one of the traders or to an agreed third party funds corresponding substantially to the product of the agreed number of the securities and the nominal derivative security value.

37. A carrier which carries a computer program comprising processor-implementable instructions for causing a computer to constitute a secondary exchange for trading derivative securities, which program comprises:
(g) code for receiving purchase offers from traders to buy the existing derivative securities;
(h) code for receiving offers of sale of the existing derivative securities from traders;
(i) code for storing the offers to buy and offers to sell in a database;
(j) code for a secondary decision step of determining whether or not a match exists between a purchase offer and an offer for sale of an existing derivative security in the database in terms of the bid and offer prices of the existing derivative security, the type of derivative security, the numerical variable and the predetermined future time; and
(k) code for a secondary trade settlement step, responsive to output from the secondary decision step that a match exists, of automatically receiving funds from a trader who has made an offer to buy the existing derivative security or from an agreed third party, notifying the traders of transfer of the derivative security from the seller to the buyer, and updating databases of the trade if it is determined that a match exists in the secondary decision step.
